(19) United States
(12) Patent Application Publication
(10) Pub. No.: US 2026/0296819 A1
(43) Pub. Date: Oct. 1, 2026

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Fumito ITO, Kanagawa (JP); Kazuhiko HORIKAWA, Kanagawa (JP); Ryosuke YONESAKA, Kanagawa (JP); Yuichi ARAKI, Kanagawa (JP)

(73) Assignee: FUJIFILM Business Innovation Corp., Tokyo (JP)

(21) Appl. No.: 19/264,848

(22) Filed: Jul. 9, 2025

(30) Foreign Application Priority Data
Mar. 25, 2025 (JP) 2025-050037

(51) Int. Cl. B65H 7/16; B65H 3/48; G06T 5/20; B65H 1/04

(52) U.S. Cl. CPC B65H 7/16; B65H 3/48; G06T 5/20; B65H 1/04; B65H 2406/10; B65H 2551/21; B65H 2553/42; G06T 2207/20192

(57) ABSTRACT

An information processing system includes a processor configured to display information representing a state of paper that floats in a case where air is blown to a side surface of a bundle of the paper; and control a flow rate of the air based on the information representing the state or an input operation.

### CROSS-REFERENCE TO RELATED APPLICATIONS

This application is based on and claims priority under 35 USC 119 from Japanese Patent Application No. 2025-050037 filed Mar. 25, 2025.

### BACKGROUND

### Technical Field

The present invention relates to an information processing system, a non-transitory computer readable medium storing a program, and an information processing method.

### Related Art

A technique is known in which air is blown to a bundle of paper stacked on a paper tray to float the paper so that an error such as double-feeding of the paper is suppressed. In such a technique, since the error suppression effect is different depending on the flow rate of air blown to the bundle of paper, a setting of the flow rate is required to improve the error suppression effect. JP2009-143665A discloses that a viewing window for observing a paper bundle is provided. JP2010-37099A discloses that the adjustment is performed while viewing a bundle of paper stacked on a paper tray that is pulled out.

### SUMMARY

However, in a case where the position at which the operation of setting the flow rate is performed and the position of the viewing window are separated from each other, it is difficult to perform the setting of the flow rate while observing the state in which the paper floats. In addition, in a state in which the paper tray is pulled out, it is difficult to observe a bundle of paper from a side surface.

Aspects of non-limiting embodiments of the present disclosure relate to an information processing system, a non-transitory computer readable medium storing a program, and an information processing method that enables a setting of a flow rate while checking a state in which air is blown to the side surface of the bundle of paper.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present invention, there is provided an information processing system including a processor configured to display information representing a state of paper that floats in a case where air is blown to a side surface of a bundle of the paper; and control a flow rate of the air based on the information representing the state or an input operation.

### BRIEF DESCRIPTION OF THE DRAWINGS

Exemplary embodiment(s) of the present invention will be described in detail based on the following figures, wherein:

FIG. 1 is a diagram illustrating an example of an overall configuration of an information processing system to which the present exemplary embodiment is applied;

FIG. 2 is a diagram illustrating an example of a hardware configuration of an image processing apparatus configuring the information processing system of FIG. 1;

FIG. 3 is a diagram illustrating an example of a functional configuration of a control unit of the image processing apparatus;

FIG. 4 is a flowchart illustrating an example of a flow of a process of the image processing apparatus;

FIG. 5 is a diagram illustrating a specific example of a paper tray of FIG. 2;

FIG. 6 is a diagram illustrating a specific example in a case where the contrast correction is added to a captured image; and

FIGS. 7A and 7B are diagrams illustrating specific examples in a case where correction for emphasizing an edge portion of paper in the captured image is added.

### DETAILED DESCRIPTION

Hereinafter, exemplary embodiments of the present invention will be described in detail with reference to the accompanying drawings.

### Configuration of Information Processing System 1

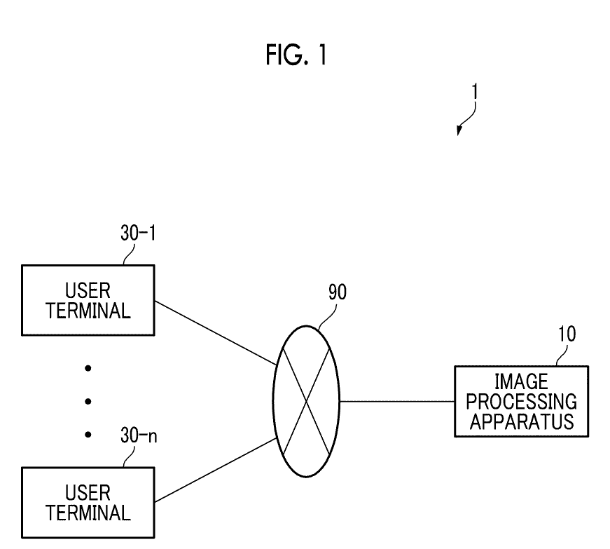

FIG. 1 is a diagram illustrating an example of an overall configuration of an information processing system 1 to which the present exemplary embodiment is applied.

The information processing system 1 is a system that enables a setting of the flow rate while checking a state in which air is blown to a side surface of a bundle of paper stacked on a paper tray. The information processing system 1 is configured by connecting the image processing apparatus 10 and user terminals 30-1 to 30-n (n is an integer equal to or greater than 1) via a network 90. The network 90 is, for example, a local area network (LAN) or the Internet. Hereinafter, the user terminals 30-1 to 30-n will be collectively referred to as a "user terminal 30" unless necessary to be individually described.

### Image Processing Apparatus 10

The image processing apparatus 10 performs various types of processes according to an input operation of a user who uses the information processing system 1. For example, the image processing apparatus 10 can execute a printing process of forming and outputting an image on paper or the like as a recording medium, a copying process of copying and outputting an image of an original document on paper or the like, a reading process of reading an image formed on paper or the like, a process of transmitting an original document by a facsimile, and the like. The image processing apparatus 10 includes, for example, a so-called electrophotographic type multifunction machine that forms a toner image on a printing surface of paper and a so-called inkjet type printer that discharges ink onto a printing surface of paper.

The image processing apparatus 10 has an operation screen as a user interface, and can acquire input information input to the operation screen and execute various types of processes. In addition, the image processing apparatus 10 can acquire various types of information transmitted from the user terminal 30 connected to the image processing apparatus 10 via the network 90 and from the outside, and execute various types of processes. In addition, the image processing apparatus 10 can transmit various types of information to the user terminal 30 and the outside.

For example, the image processing apparatus 10 displays, on the operation screen, information representing a state of paper floating by blowing air to a side surface of a bundle of paper stacked on the paper tray. Here, the "side surface of the bundle of paper" refers to a set of edge portions of each of the plurality of paper stacked on the paper tray.

In addition, the "information representing the state of floating paper" may be called as, for example, a captured image in which the state of the floating paper is captured (hereinafter, simply referred to as a "captured image"), a numerical value representing the state of the floating paper calculated by a predetermined method, or the like. In the present exemplary embodiment, it is assumed that the captured image as the information representing the state of the floating paper is displayed on the operation screen.

The captured image displayed on the operation screen is captured by a camera that captures the side surface of the bundle of paper stacked on the paper tray. The captured image may be displayed on the operation screen of the image processing apparatus 10 or may be displayed on the operation screen of the user terminal 30.

The image processing apparatus 10 can control the flow rate of air blown to the side surface of the bundle of paper based on the captured image as the information representing the state of the floating paper. In addition, the image processing apparatus 10 controls the flow rate of air blown to the side surface of the bundle of paper based on the input operation of the user. In this case, the user who performs the input operation performs the input operation while viewing the captured image displayed on the operation screen of the image processing apparatus 10 or the operation screen of the user terminal 30. Here, the "input operation" by the user includes, for example, an input operation for a button or a gauge for adjusting the flow rate, which is displayed on the operation screen.

The image processing apparatus 10 can correct the captured image based on the information obtained from the captured image or the input information input by the input operation, and can display the corrected captured image on the operation screen. In this case, in a case where it is difficult to discriminate the portion of the paper from the captured image displayed on the operation screen, the image processing apparatus 10 can add correction to make the portion of the paper be easily discriminated from the captured image. For example, the image processing apparatus 10 can add the following corrections on the captured image. That is, the image processing apparatus 10 can add the contrast correction of the captured image. In addition, the image processing apparatus 10 can add correction for emphasizing the edge portion of the paper in the captured image.

In addition, the image processing apparatus 10 can display the captured image, which is displayed on the operation screen in the past, again on the operation screen. The details of configuration and process of the image processing apparatus 10 will be described later.

### User Terminal 30

The user terminal 30 is an information processing apparatus such as a smartphone, a tablet terminal, or a personal computer operated by the user who uses the information processing system 1. The user terminal 30 is installed with application software that enables the generation of print data, the issuance of an instruction to execute the printing process or the like to the image processing apparatus 10 via the operation screen as the user interface.

The user terminal 30 can transmit various types of information to the image processing apparatus 10 and the outside. For example, the user terminal 30 can generate the print data based on the input operation of the user and transmit the print data to the image processing apparatus 10. In addition, the user terminal 30 can transmit an instruction to execute the printing process or the like to the image processing apparatus 10.

In addition, the user terminal 30 can acquire various types of information transmitted from the image processing apparatus 10 and the outside, and execute various types of processes. For example, the user terminal 30 acquires the captured image transmitted from the image processing apparatus 10 and displays the captured image on the operation screen.

The above configuration of the information processing system 1 is merely an example, and the information processing system 1 as a whole may have functions that realize the above processing. Therefore, a part or all of the functions for realizing the process described above may be shared or cooperated in the information processing system 1. That is, a part or all of the functions of the image processing apparatus 10 configuring the information processing system 1 may be used as the functions of another information processing apparatus (for example, the user terminal 30). In addition, a part or all of the function of another information processing apparatus may be used as the function of the image processing apparatus 10. Further, a part or all of the functions of the image processing apparatus 10 or other apparatuses which configure the information processing system 1 may be transferred to another server (not illustrated). Accordingly, the processing of the information processing system 1 as a whole may be accelerated, and, in addition, the processing can also be complemented.

### Hardware Configuration

### Hardware Configuration of Image Processing Apparatus 10

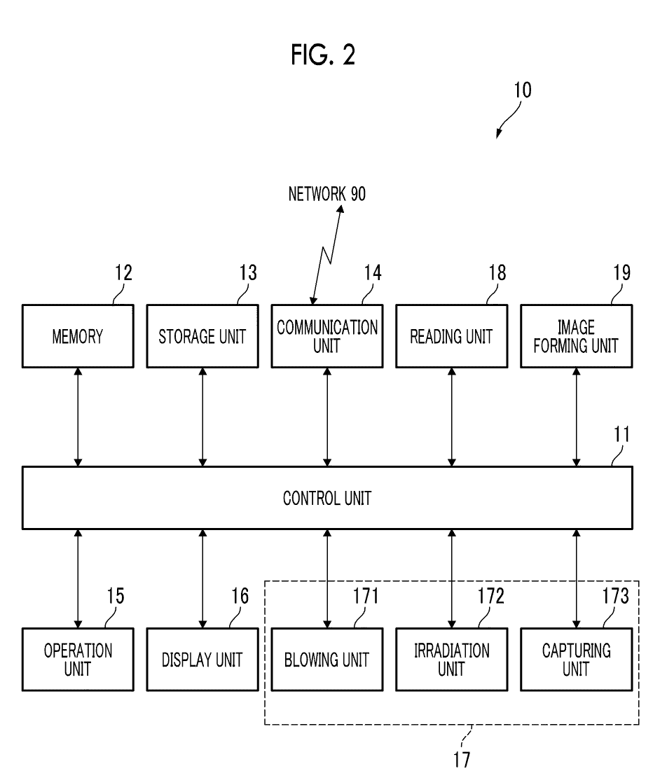

FIG. 2 is a diagram illustrating an example of a hardware configuration of the image processing apparatus 10 configuring the information processing system 1 of FIG. 1.

The image processing apparatus 10 includes a control unit 11, a memory 12, a storage unit 13, a communication unit 14, an operation unit 15, a display unit 16, a paper tray 17, a reading unit 18, and an image forming unit 19. The above units are connected to each other via a data bus, an address bus, a Peripheral Component Interconnect (PCI) bus, or the like.

The control unit 11 is a processor that controls functions of the image processing apparatus 10 based on execution of various types of software such as an OS (basic software) and application software.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other.

The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content

The memory 12 is a storage region in which various types of software, pieces of data used for executing the software, or the like are stored, and is used as a work area in calculations. The memory 12 is configured of, for example, a random access memory (RAM).

The storage unit 13 is a storage region in which input data for various types of software, output data from various types of software, or the like are stored. The storage unit 13 is configured of, for example, a hard disk drive (HDD), a solid state drive (SSD), or a semiconductor memory, which is used for storing programs, various types of setting data, or the like. The storage unit 13 is provided with a database that stores various types of information.

The communication unit 14 transmits and receives data to and from the user terminal 30 and an outside via the network 90. The operation unit 15 is configured of, for example, a keyboard, a mouse, a mechanical button, or a switch, and receives an input operation.

The operation unit 15 also includes a touch sensor integrally configuring a touch panel with the display unit 16.

The display unit 16 is configured of, for example, a liquid crystal display or an organic electroluminescence (EL) display to be used for information display, and displays data of an image or a text and the like. The display unit 16 displays a user interface or the like.

The paper tray 17 is a mechanism that can stack and store paper to be used for printing, is disposed inside the image processing apparatus 10, or is disposed outside the image processing apparatus 10. The paper tray 17 corresponds to, for example, various paper sizes such as A4, A3, and letter size. The paper tray 17 includes a paper feeding tray (also referred to as an “input tray”), a paper discharge tray (also referred to as an “output tray”), a manual feed tray, and the like.

The paper feeding tray is a tray on which blank paper can be stacked before printing. In many cases, paper having different sizes and types are simultaneously stacked on each of the plurality of paper feeding trays. The paper discharge tray is a tray from which paper on which the printing is completed is discharged. The manual feed tray is an auxiliary tray used in a case of printing a small amount of special paper (for example, thick paper or an envelope). The paper tray 17 in the present exemplary embodiment is a paper feeding tray, and is configured to enable continuous printing by stacking several hundreds of sheets of paper.

The paper tray 17 includes a blowing unit 171 that blows air toward the side surface of the bundle of stacked paper, an irradiation unit 172 that irradiates the side surface of the bundle of stacked paper with light, and a capturing unit 173 as capturing means that captures the side surface of the bundle of stacked paper. The blowing unit 171 blows air toward the side surface of the bundle of paper that are stacked to separate and float the paper one by one. Accordingly, the occurrence of a double-feeding error in which a plurality of sheets of paper are fed in a state in which the paper are stuck together is suppressed. The blowing unit 171 is particularly effective in a case where a large amount of printing is performed or in an environment in which the paper is likely to stick due to humidity. The blowing unit 171 is configured of, for example, a fan or an air duct disposed in the paper tray 17.

The irradiation unit 172 is configured by a light source such as a Light Emitting Diode (LED), and irradiates the side surface of the bundle of stacked paper with light. As a result, the capturing by the capturing unit 173 which will be described later is assisted.

The capturing unit 173 is configured of a camera, an image sensor, an optical unit, or the like, and captures a side surface of a bundle of stacked paper. The camera is configured of, for example, a multi-wavelength spectroscopic camera. The multi-wavelength spectroscopic camera includes, for example, a hyperspectral camera, a multispectral camera, and a camera in which a color filter portion of an RGB camera is changed for a predetermined wavelength. In addition, the camera may be an infrared camera having a single wavelength.

The reading unit 18 reads an image recorded on a medium such as paper. The reading unit 18 may be configured of, for example, a Charge Coupled Devices (CCD) type scanner that reduces reflected light with respect to light emitted from a light source to an original document with a lens and receives the reflected light with a CCD. In addition, the reading unit 18 may be configured of a Contact Image Sensor (CIS) type scanner or the like that receives reflected light with a CIS with respect to light emitted in order from an LED light source to an original document.

The image forming unit 19 forms an image to be printed on a printing surface of paper as a recording medium by, for example, an electrophotographic method, an inkjet method, or the like.

### Hardware Configuration of User Terminal 30

The user terminal 30 includes a control unit, a memory, a storage unit, a communication unit, an operation unit, and a display unit respectively corresponding to the control unit 11, the memory 12, the storage unit 13, the communication unit 14, the operation unit 15, and the display unit 16 illustrated in FIG. 2. These units are connected to each other via a data bus, an address bus, a PCI bus, or the like.

### Functional Configuration

### Functional Configuration of Image Processing Apparatus 10

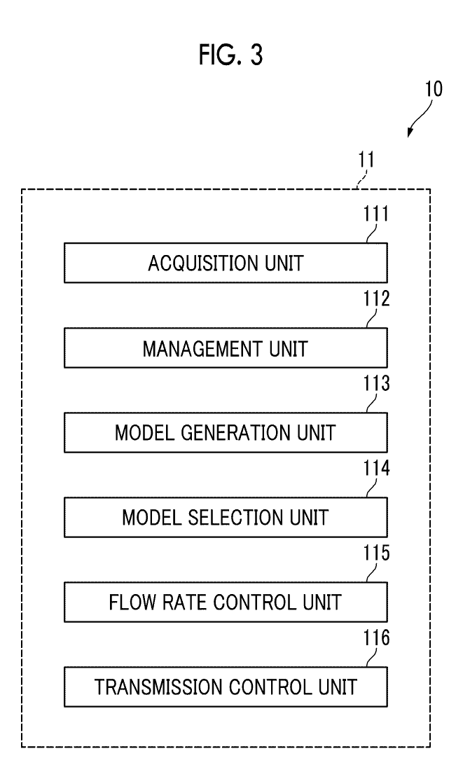

FIG. 3 is a diagram illustrating an example of a functional configuration of the control unit 11 of the image processing apparatus 10.

In the control unit 11 of the image processing apparatus 10, an acquisition unit 111, a management unit 112, a correction unit 113, a display control unit 114, a flow rate control unit 115, and a transmission control unit 116 function.

The acquisition unit 111 acquires various types of information. For example, the acquisition unit 111 acquires the input information input to the operation screen displayed on the display unit 16 (see FIG. 2). In addition, the acquisition unit 111 acquires the input information input to the operation screen displayed on the user terminal 30. In addition, the acquisition unit 111 acquires setting information of the flow rate in which the blowing unit 171 (see FIG. 2) of the paper tray 17 blows air toward the bundle of paper. In addition, the acquisition unit 111 acquires the captured image captured by the capturing unit 173 (see FIG. 2) of the paper tray 17.

The management unit 112 stores and manages various types of information in the database of the storage unit 13 (see FIG. 2). For example, the management unit 112 stores and manages the captured image as the information representing the state of the floating paper, which is acquired by the acquisition unit 111, in the database.

In a case where it is difficult to identify the paper in the captured image managed by the management unit 112, the correction unit 113 easily identifies the paper by correcting the captured image. For example, the correction unit 113 corrects the contrast of the captured image. Specifically, the correction unit 113 performs image processing of performing a conversion process along a default tone curve that darkens a dark portion and brightens a bright portion from the brightness value of the captured image, as the contrast correction. More specifically, the correction unit 113 performs interpolation by assigning the maximum value, the minimum value, and the intermediate value of the brightness values calculated from the captured image to the default tone curve.

Even in a case where such correction is performed, it may be difficult to discriminate the portion of the paper. In this case, the correction unit 113 adds correction to a tone curve. Specifically, the correction unit 113 adjusts the threshold values of the bright portion and the dark portion or how much the brightness should be increased after the contrast correction is performed as the tone curve correction.

In addition, the correction unit 113 adds correction for emphasizing the edge portion of the paper in the captured image. The correction unit 113 can perform the contrast correction of the captured image and correction for emphasizing the edge portion of the paper in the captured image at the same time. The correction by the correction unit 113 may be configured to be automatically performed by the correction unit 113, or may be configured to be performed by the correction unit 113 according to an input operation of the user.

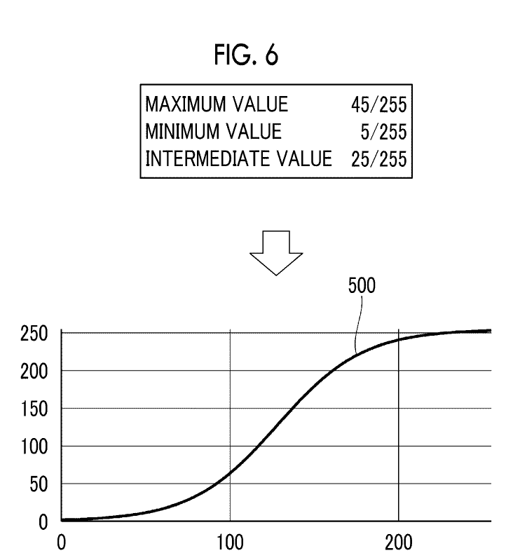

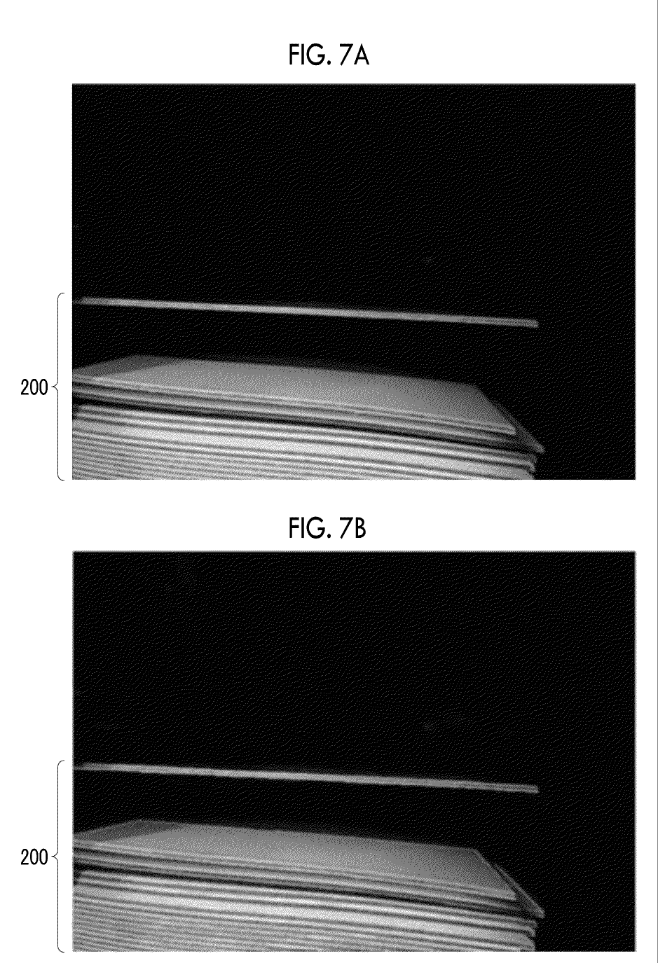

In a case where the correction unit 113 performs the correction according to the input operation of the user, for example, in a case where a setting button (for example, a check box or the like) disposed on the operation screen is pressed, the correction of the captured image may be performed. The correction by the correction unit 113 is not limited to these corrections, and may be other various corrections. A specific example of the correction of the captured image will be described later with reference to FIGS. 6, 7A and 7B.

The display control unit 114 controls the operation screen for operating the image processing apparatus to be displayed on the display unit 16 (see FIG. 2) of the image processing apparatus. In addition, the display control unit 114 controls the captured image to be displayed on the operation screen of the image processing apparatus. In addition, the display control unit 114 controls the operation screen for operating the image processing apparatus 10 to be displayed on the display unit of the user terminal 30. In addition, the display control unit 114 controls the captured image to be displayed on the operation screen of the user terminal 30.

In addition, the display control unit 114 controls the captured image displayed on the operation screen in the past again to be displayed on the operation screen. In this case, for example, the display control unit 114 controls, among the captured images displayed on the operation screen in the past, a captured image having a predetermined similarity to be displayed on the operation screen. In addition, the display control unit 114 controls, among the captured images displayed in the past, the captured image for which the image forming process has succeeded to be displayed on the operation screen. In addition, the display control unit 114 controls, among the captured images displayed in the past, a captured image that has not succeeded in the image forming process to be displayed on the operation screen. In this case, the display control unit 114 may perform control to display information indicating whether or not the operation is successful on the operation screen together.

The flow rate control unit 115 controls the flow rate of air blown by the blowing unit 171 (see FIG. 2) toward the bundle of paper. The flow rate control unit 115 controls the flow rate according to the input operation of the user or automatically. In a case where the flow rate is automatically controlled, the flow rate control unit 115 detects the edge portion of the paper from the captured image to determine the floating state of the paper, and adjusts the flow rate based on the determination result and the setting information of the flow rate.

The transmission control unit 116 controls to transmit various types of information to the user terminal 30 and the outside via the communication unit 14 (see FIG. 2). For example, the transmission control unit 116 controls to transmit the captured image managed by the management unit 112 to the user terminal 30.

### Flow of Process of Image Processing Apparatus 10

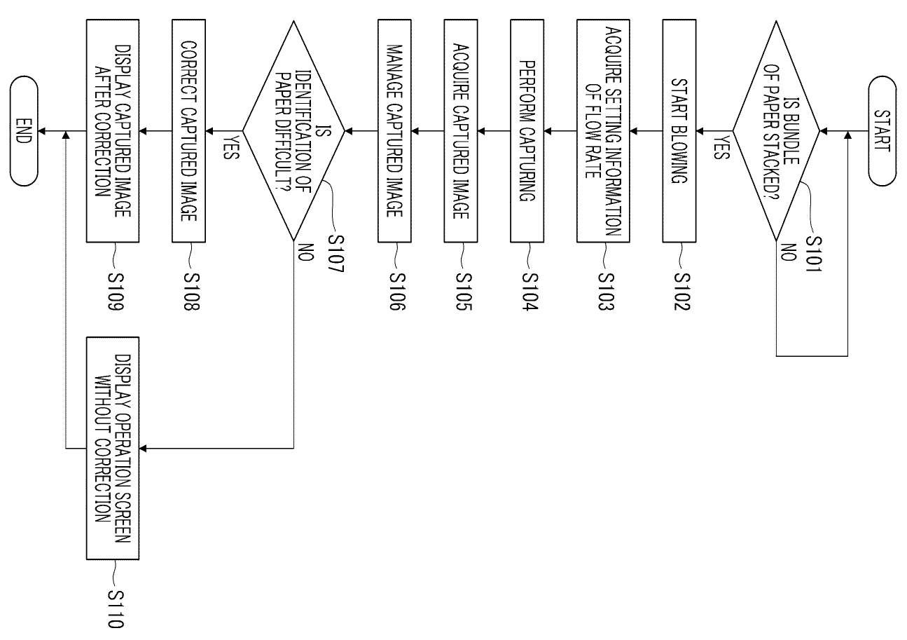

FIG. 4 is a flowchart illustrating an example of a flow of a process of the image processing apparatus 10.

In a case where a bundle of paper is stacked on the paper tray (YES in step S101), the image processing apparatus 10 starts blowing air (step S102). Specifically, the image processing apparatus 10 starts a process of blowing air toward the side surface of the bundle of paper stacked on the blowing unit 171 (see FIG. 2) of the paper tray 17. On the other hand, in a case where the bundle of paper is not stacked on the paper tray (NO in step S101), the image processing apparatus 10 repeats the determination process in step S101.

The image processing apparatus 10 acquires setting information of the flow rate in which the blowing unit 171 blows air toward the bundle of paper (step S103). In addition, the image processing apparatus 10 captures a state in which the paper floats from the bundle of paper (step S104). Specifically, the image processing apparatus 10 causes the irradiation unit 172 (see FIG. 2) to irradiate the bundle of paper with light, and causes the capturing unit 173 (see FIG. 2) to capture the state in which the paper floats from the bundle of paper.

The image processing apparatus 10 acquires the captured image captured in step S104 (step S105), and stores and manages the captured image in the database of the storage unit 13 (see FIG. 2) (step S106). In a case where it is difficult for the user to identify the paper (YES in step S107) in a case where the captured image is displayed on the operation screen, the image processing apparatus 10 corrects the captured image (step S108). In this case, whether or not it is difficult for the user to identify the paper may be configured to be automatically determined by the image processing apparatus 10 or may be configured such that the correction is instructed by an input operation of the user.

The image processing apparatus 10 displays the corrected captured image on the operation screen (step S109) and ends the process (END). On the other hand, in a case where it is not difficult to identify the paper in the captured image (NO in step S107), the captured image is displayed on the operation screen without correction (step S110), and the process ends (END).

### Specific Example

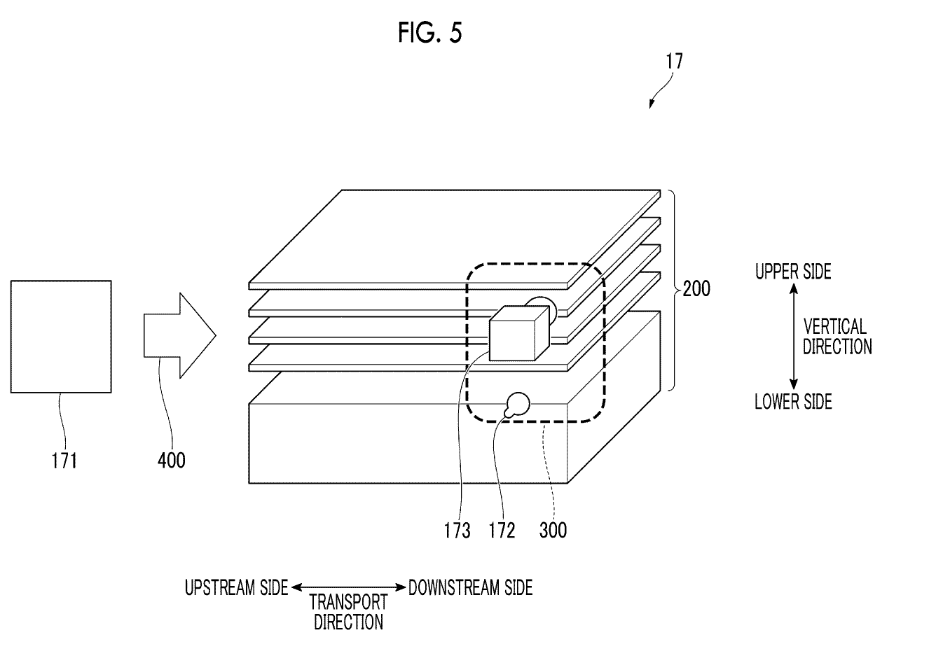

FIG. 5 is a diagram illustrating a specific example of the paper tray 17 in FIG. 2.

As illustrated in FIG. 5, the blowing unit 171 that blows air 400 toward the side surface of the bundle of the stacked paper 200 to float the paper 200 one by one is disposed in the paper tray 17. In addition, the paper tray 17 is disposed with an irradiation unit 172 that irradiates the side surface of the bundle of the paper 200 with light and a capturing unit 173 that captures a capturing area 300 of a part of the side surface of the bundle of the paper 200.

In FIG. 5, a direction in which the paper 200 is transported is referred to as a “transport direction”. The paper 200 stacked on the paper tray 17 is transported toward the downstream side in the transport direction. In addition, a direction in which the paper 200 floats by blowing the air 400 toward the bundle of the paper 200 is referred to as a “vertical direction”. The paper 200 to which the air 400 is blown floats upper side in the vertical direction.

FIG. 6 is a diagram illustrating a specific example in a case where the contrast correction of the captured image is added.

The paper 200 (see FIG. 5) stacked in the paper tray 17 may be colored such as black. In this case, it may be difficult to identify a boundary between a portion corresponding to the paper 200 and a portion corresponding to the background in the captured image displayed on the operation screen. In such a case, the image processing apparatus 10 corrects the contrast of the captured image using, for example, the following method.

That is, the image processing apparatus 10 calculates the maximum value, the minimum value, and the intermediate value of the brightness value from the captured image. FIG. 6 illustrates, as a specific example, that the maximum value of the calculated brightness value is "45/255", the minimum value is "5/255", and the intermediate value is "25/255". The image processing apparatus 10 performs interpolation by assigning the calculated maximum value, minimum value, and intermediate value of the brightness value to a default tone curve 500 illustrated in FIG. 6.

In a case where it is still difficult to discriminate the portion of the paper 200 even after such correction, the image processing apparatus 10 performs adjustment of the tone curve 500 as further correction. In this case, the image processing apparatus 10 may perform the adjustment of the tone curve 500 according to the input operation of the user or automatically.

FIGS. 7A and 7B are diagrams illustrating specific examples in a case where correction for emphasizing the edge portion of the paper 200 in the captured image is added.

FIG. 7A illustrates a captured image before the correction is performed by the image processing apparatus 10. FIG. 7B illustrates the captured image after the correction is performed by the image processing apparatus 10. The captured images illustrated in FIGS. 7A and 7B are both captured images of the capturing area 300 of FIG. 5 described above.

As in the example of FIG. 6 described above, in a case where the color of the paper 200 stacked on the paper tray 17 (see FIG. 5) is colored such as black, it may be difficult to identify the boundary between the portion corresponding to the paper and the portion corresponding to the background in the captured image displayed on the operation screen. In such a case, the image processing apparatus 10 performs correction of emphasizing the edge portion of the paper in the captured image. Specifically, the image processing apparatus 10 emphasizes a contour or a boundary in the captured image by applying a process of an edge detection filter with respect to the captured image.

### Other Exemplary Embodiments

While the present exemplary embodiments have been described above, the present invention is not limited to the exemplary embodiments. In addition, effects of the present invention are not limited to the effects disclosed in the exemplary embodiments. For example, both the overall configuration of the information processing system 1 illustrated in FIG. 1 and the hardware configuration of the image processing apparatus 10 illustrated in FIG. 2 are merely examples for achieving the purpose of the present invention, and are not particularly limited.

In addition, the functional configuration of the image processing apparatus 10 illustrated in FIG. 3 is merely an example and is not particularly limited. As long as the information processing system 1 in FIG. 1 is provided with a function with which the above processing can be executed as a whole, a functional configuration to be used to implement the function is not limited to the example in FIG. 3. In addition, the order of the steps of the process of the image processing apparatus 10 illustrated in the flowchart of FIG. 4 is merely an example and is not particularly limited. Not only the processing is performed in time series along the illustrated order of the steps, but also the processing may not be performed in time series and may be parallelly or individually performed. In addition, the specific examples illustrated in FIGS. 5-7 are merely an example and are not particularly limited.

In addition, in the above-described exemplary embodiment, the paper tray is described as the paper feeding tray, but the present invention is not limited thereto, and may be, for example, a paper discharge tray.

The present invention can also be applied to a program and a program product.

### Supplementary Note

### 1

An information processing system comprising:
a processor configured to:
display information representing a state of paper that floats in a case where air is blown to a side surface of a bundle of the paper; and
control a flow rate of the air based on the information representing the state or an input operation.

### 2

The information processing system according to (((1))),
wherein the information representing the state is a captured image of the side surface of the bundle of the paper.

### 3

The information processing system according to (((1))) or (((2))),
wherein the captured image is information acquired by an image processing apparatus including a paper tray on which the bundle of the paper is stacked and a capturing unit that captures the side surface of the bundle of the paper.

### 4

The information processing system according to (((2))), wherein the processor is configured to:
add correction to the captured image based on information obtained from the captured image or the input operation; and
display the captured image obtained after the correction.

### 5

The information processing system according to (((4))), wherein the processor is configured to:
display the captured image to which contrast correction is added as the correction.

### 6

The information processing system according to (((5))), wherein the processor is configured to:
further display the captured image to which tone curve correction is added.

### 7

The information processing system according to (((4))), wherein the processor is configured to:
display the captured image to which correction for emphasizing an edge portion of the paper is added as the correction.

### 8

The information processing system according to any one of ((1)) to ((7)), wherein the processor is configured to:
further display the information representing the state displayed in past.

### 9

The information processing system according to (((8))), wherein the processor is configured to:
display information having a predetermined similarity among the information representing the state displayed in the past.

### 10

The information processing system according to (((8))), wherein the processor is configured to:
display at least one of information for which an image forming process is successful or information for which an image forming process is not successful among the information representing the state displayed in the past, together with information representing whether or not the process is successful.

### 11

A program executed by a computer that controls an image processing apparatus, the program causing the computer to realize:
a function of displaying information representing a state of paper that floats in a case where air is blown to a side surface of a bundle of the paper; and
a function of controlling a flow rate of the air based on the information representing the state or an input operation.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
display information representing a state of paper that floats in a case where air is blown to a side surface of a bundle of the paper; and
control a flow rate of the air based on the information representing the state or an input operation.

2. The information processing system according to claim 1,
wherein the information representing the state is a captured image of the side surface of the bundle of the paper.

3. The information processing system according to claim 2,
wherein the captured image is information acquired by an image processing apparatus including a paper tray on which the bundle of the paper is stacked and a capturing unit that captures the side surface of the bundle of the paper.

4. The information processing system according to claim 2, wherein the processor is configured to:
add correction to the captured image based on information obtained from the captured image or the input operation; and
display the captured image obtained after the correction.

5. The information processing system according to claim 4, wherein the processor is configured to:
display the captured image to which contrast correction is added as the correction.

6. The information processing system according to claim 5, wherein the processor is configured to:
further display the captured image to which tone curve correction is added.

7. The information processing system according to claim 4, wherein the processor is configured to:
display the captured image to which correction for emphasizing an edge portion of the paper is added as the correction.

8. The information processing system according to claim 1, wherein the processor is configured to:
further display the information representing the state displayed in past.

9. The information processing system according to claim 8, wherein the processor is configured to:
display information having a predetermined similarity among the information representing the state displayed in the past.

10. The information processing system according to claim 8, wherein the processor is configured to:
display at least one of information for which an image forming process is successful or information for which an image forming process is not successful among the information representing the state displayed in the past, together with information representing whether or not the process is successful.

11. A non-transitory computer readable medium storing a program executed by a computer that controls an image processing apparatus, the program causing the computer to realize:
a function of displaying information representing a state of paper that floats in a case where air is blown to a side surface of a bundle of the paper; and
a function of controlling a flow rate of the air based on the information representing the state or an input operation.

12. An information processing method comprising:
displaying information representing a state of paper that floats in a case where air is blown to a side surface of a bundle of the paper; and
controlling a flow rate of the air based on the information representing the state or an input operation.
